(19) United States
(12) Patent Application Publication
(10) Pub. No.: US 2007/0008141 A1
(43) Pub. Date: Jan. 11, 2007

(54) BATTERY IDENTIFICATION SYSTEM AND METHOD

(75) Inventor: Todd Sweetland, Wilsonville, OR (US)

Correspondence Address: DAVIS WRIGHT TREMAINE, LLP, 2600 CENTURY SQUARE, 1501 FOURTH AVENUE, SEATTLE, WA, 98101-1688, US

(73) Assignee: MICROPOWER ELECTRONICS INC., Hillsboro, OR (US)

(21) Appl. No.: 11/420,705

(22) Filed: May 26, 2006

Related U.S. Application Data
(60) Provisional application No. 60/698,293, filed on Jul. 11, 2005.

(51) Int. Cl. G08B 13/14

(52) U.S. Cl. 340/572.7

(57) ABSTRACT

A battery identification system and method using identifiers affixed to batteries and/or to a battery case of a battery pack allows for identification and tracking of the batteries and the battery case throughout their life in varied environments even when the battery pack itself is un-usable. Identification and tracking can be accomplished without need for the batteries or the battery pack to be physically inserted into a reader or other device. Consequently, identification and tracking of the batteries and the battery pack may be expedited.

### CROSS REFERENCE TO RELATED APPLICATION

This application claims priority benefit of provisional application Ser. No. 60/698,293 filed Jul. 11, 2005.

### BACKGROUND OF THE INVENTION

Electrical batteries are used in wide range of devices including devices that are depended upon to have extraordinary reliability. Electrical batteries typically must be replaced periodically. Even rechargeable batteries have lifetimes of a certain number of recharge cycles. To assist with the logistics of assuring that fresh batteries are available for various devices, some conventional approaches have incorporated a fuel gauge chip or other identification technology that is used with some batteries designated as smart batteries.

These conventional approaches use power from the battery itself and are therefore dependent upon having the battery electrically connected to its device or some sort of reader. Unfortunately, this requirement of connectivity with the battery itself can hinder accessibility to identification data and other types of data on the battery. For instance, situations arise when identification and other information about a battery or battery pack must be quickly ascertained without requiring electrical connection of a reader.

### BRIEF DESCRIPTION OF THE SEVERAL VIEWS OF THE DRAWING(S)

FIG. 1 is a schematic of an implementation of a battery identification system.

FIG. 2 is an isometric view of a battery showing placement of an identifier on the battery.

FIG. 3 is an isometric view of a battery case of a battery pack showing placement of an identifier on the case.

FIG. 4 is an isometric view of the battery case of FIG. 3 showing two instances of the battery of FIG. 2 to be placed into the battery case.

FIG. 5 is an isometric view of the battery case of FIG. 3 with the instances of the battery of FIG. 4 being placed inside of the battery case to form a battery pack.

### DETAILED DESCRIPTION

As disclosed herein, a battery identification system and method using identifiers affixed to batteries and/or to a battery case of a battery pack allows for identification and tracking of the batteries and the battery case throughout their life in varied environments even when the battery pack itself is un-usable. Identification and tracking can be accomplished without need for the batteries or the battery pack to be physically inserted into a reader or other device. Consequently identification and tracking of the batteries and the battery pack may be expedited.

Radio frequency identification (RFID) tags, typically made from chips, paper labels, or other structures, are used as the identifiers to store and remotely provide data associated with the batteries and the battery pack. The RFID tags are small enough to be affixed directly on to the batteries and/or the battery pack. In some instances a single identifier is mounted to an inside wall of the battery pack. In passive tag implementations, the identifiers need no dependent electrical connections to the batteries inside of the battery pack. Identification of the batteries and the battery pack can be accomplished in a rapid way by passing an RFID reader in their proximity, with little or no disruption to their status.

RFID tags contain antennas, which receive and transmit responses to radio-frequency queries from an RFID transceiver incorporated into an RFID reader. The RFID reader can be handheld to be passed in the vicinity of the RFID tags when collecting data stored on the RFID tags. Passive tags require no internal power source, whereas active tags require a power source.

For passive tags of an inductive style, a small current induced in the antenna by the incoming radio frequency signal provides just enough power for the tag to transmit a response. Due to limited power and cost, the response of a passive RFID tag is brief. The passive tag can also be small. Passive tags have practical read distances ranging from about less than an inch to about 20 feet. Because passive tags are cheaper to manufacture and have no battery, the majority of RFID tags in existence are of the passive variety.

Inductive RFID tags are powered at least in part by the magnetic field generated by the reader. The inductive RFID tags generally have a silicon microprocessor, a metal coil antenna, and encapsulating material. Capacitively coupled RFID tags tend to be less expensive than the inductive style of RFID tags. The capacitive tags typically do not have a metal coil antenna and instead use a conductive carbon ink that is applied to the paper substrate by a printing process. The capacitive tags have a type of silicon processor than is coupled to printed carbon-ink electrodes on the back of a paper label. Although the capacitively coupled RFID tags can be less expensive than the inductively coupled RFID tags, the capacitively coupled RFID tags typically have shorter range than the inductively coupled tags.

Since active RFID tags have an internal power source they may have longer range and larger memories than passive tags. The internal power source of an active RFID tag can have a life of up to 10 years. The active RFID tags may also have the ability to store additional information sent by the transceiver. At present, the smallest active tags are about the size of a coin. Many active tags have practical ranges of tens of yards. While the cost advantages of passive tags over active tags are significant, other factors including accuracy, performance in certain environments such as around water or metal, and reliability favor active tags in certain implementations.

Active and passive RFID tags are generally divided into groups: read-write, write-once and read-many (WORM), and read only. Read-write tags allow data to be changed during operations when data having a certain degree of variability needs to be updated. In many implementations, the battery pack identifiers could use write-once, read-many (WORM) type or possibly the read only type of RFID tags since the type of data being stored in the identifiers about the battery packs would not have to be updated. In other implementations the WORM style of RFID tag may be useful if some of the identifier data has to be updated during the lifetime of the battery pack.

RFID tags available for use include the following four classes: low frequency RFID tags (125 or 134.2 kHz), high frequency RFID tags (13.56 MHz), UHF RFID tags (868 to 956 MHz), and microwave RFID tags (2.45 GHz). There are some transponder devices and contactless chip cards which can deliver a similar function and can be used in alternative implementations.

The system generally can include RFID tags and at least one reader to collect data from the RFID tags on the batteries and possibly also encode data onto the RFID tags. The system can also include various computers, servers, networks, other devices and associated software to store and distribute the collected battery data. Some implementations may simply utilize RFID tagged batteries along and a simple RFID reader. Other implementations can include battery packs, and hardware and software associated with their more elaborate approaches.

In a typical implementation, each of the batteries of a battery pack as well as the case or other structure of the battery pack is equipped with a small, inexpensive RFID tag. The RFID tag contains a transponder with a digital memory chip that is given a unique electronic product code. The RFID reader has an antenna packaged with a transceiver and decoder. The reader emits a signal having an effective strength in a zone that extends a certain distance from the reader dependant upon various factors including environment and characteristics of the RFID tag. When an RFID tag is in the zone, the reader is able to read and perhaps write data to the RFID tag.

Implementations include, for example, battery pack applications for high reliability medical devices in which a high degree of traceability and reporting of the battery packs is required. In many cases this could be separate from any electronics already in the battery pack such as fuel gauge, other types of identification chips, protection circuit, etc. The identifier would allow an end-user or other party to obtain information about the battery pack such as serial number, manufacture site, manufacture date, customer name, end unit serial number, and line leaders name from the battery with an RFID reader without extensive coordination and without elaborate pre-planning to obtain such data.

For example, such information could be obtained from the battery pack in various settings such as in a warehouse, during operation in the field, during transit as the battery pack is being shipped, etc. without having to physically place the battery pack into a reader or other device such as its end unit. This approach of the system could be a great benefit for identifying a battery pack that has been otherwise destroyed or damaged to the point where it can no longer be powered in its end unit so that data stored conventionally could not be accessed.

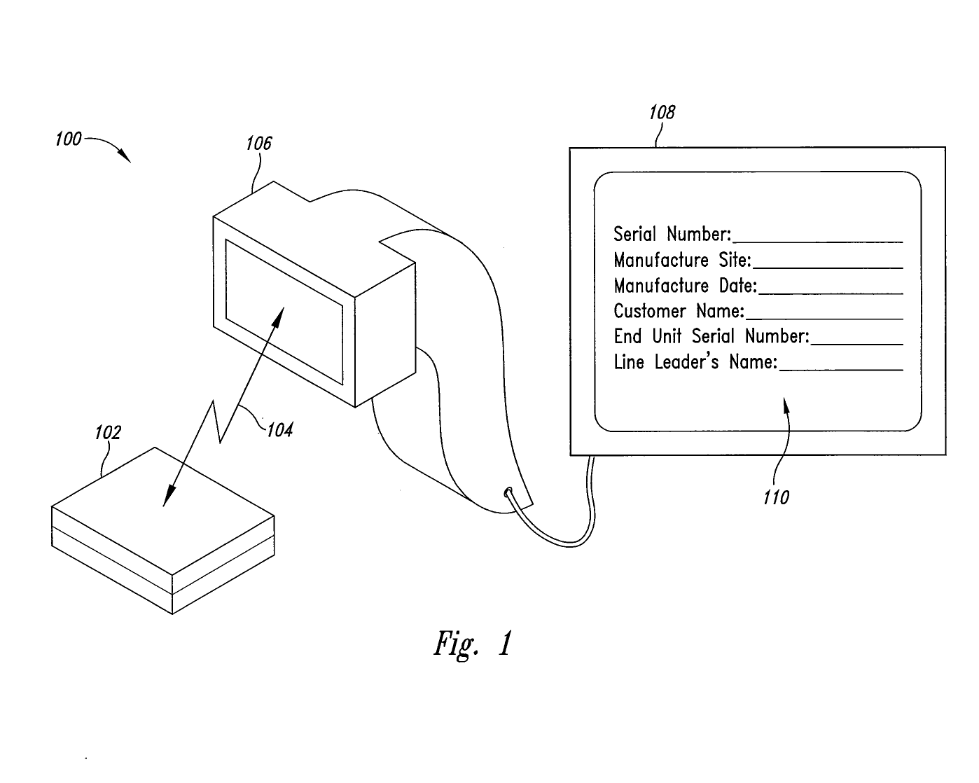

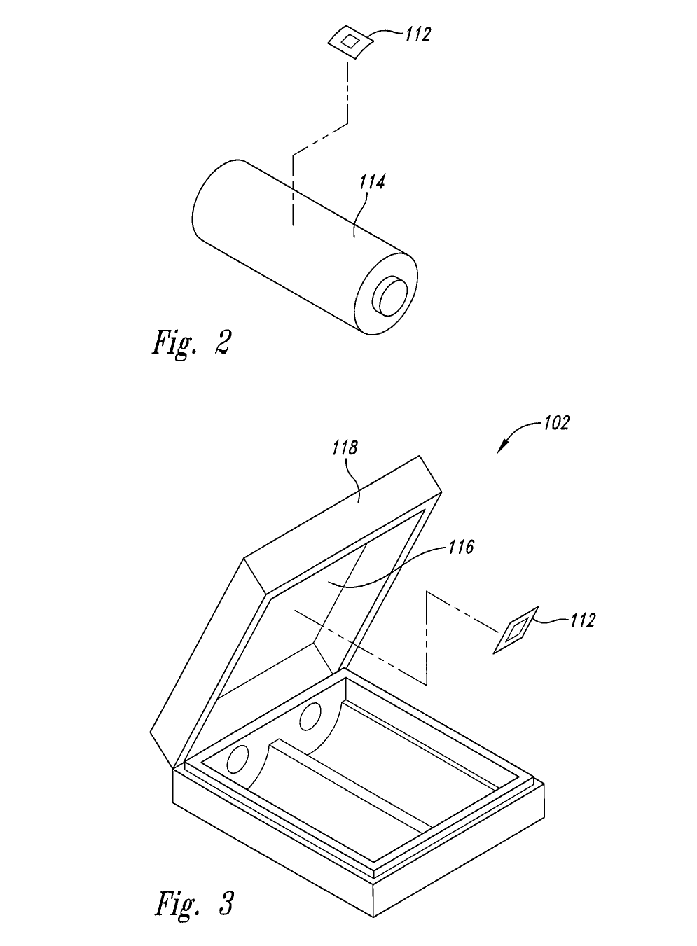

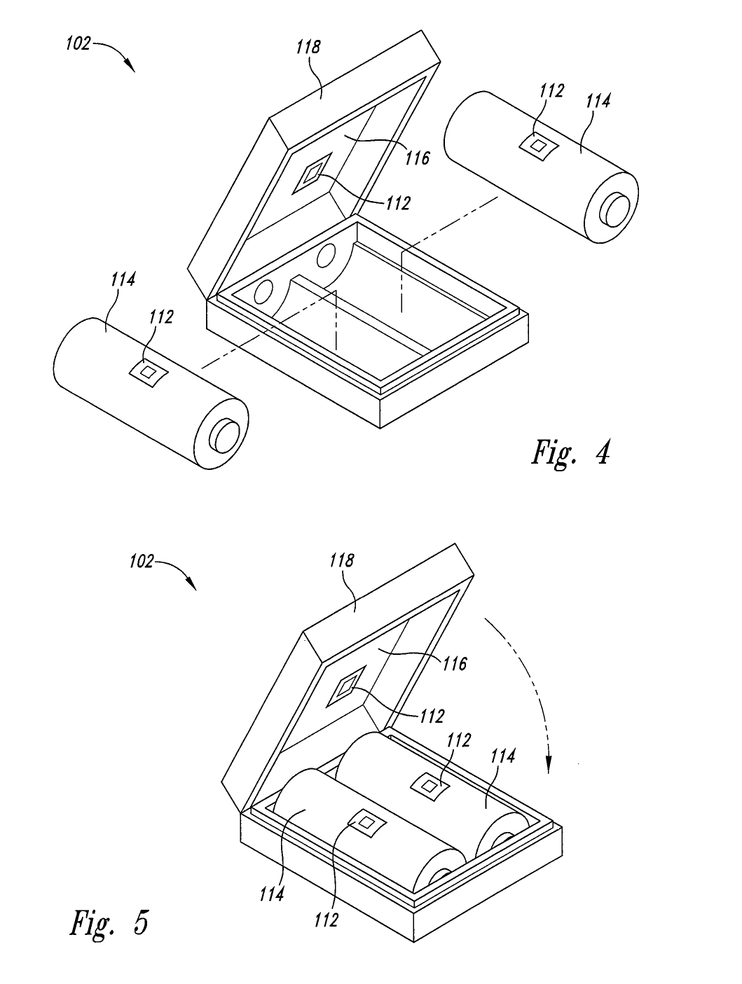

An implementation 1 00 of the system is shown in FIG. 1 as having a battery pack 102 that communicates via a signal 104 with an RFID reader 106, which then shows on a display 108 data 110 stored in one or more identifiers 112 shown in FIGS. 2 and 3. The depicted implementation includes methods in which RFID tags and battery packs are provided. The RFID tags are used as the identifiers 1 12 and are affixed either directly to one or more batteries 1 14 as shown in FIG. 2 and/or directly affixed to a structural member of the battery pack 102 such as on a cover inside surface 116 of a case 118 of the battery pack 102 as shown in FIG. 3. The RFID tags as the identifiers 112 can then be read by the RFID reader 106 to obtain information about the battery pack 102. Given the relatively small dimensions of the RFID tag identifiers 112, the batteries 114 are able to fit into the case 11 8 with little or no modification to the case as shown in FIGS. 4 and 5.

From the foregoing it will be appreciated that, although specific embodiments of the invention have been described herein for purposes of illustration, various modifications may be made without deviating from the spirit and scope of the invention. Accordingly, the invention is not limited except as by the appended claims.

The invention claimed is

1. A system comprising:
a battery pack; and
an RFID tag containing information about the battery pack, the RFID tag affixed to the battery pack.

2. The system of claim 1 wherein the RFID tag contained information includes battery pack serial number.

3. The system of claim 1 wherein the RFID tag contained information includes battery pack manufacture site.

4. The system of claim 1 wherein the RFID tag contained information includes battery pack manufacture date.

5. The system of claim 1 wherein the RFID tag contained information includes battery pack customer name.

6. The system of claim 1 wherein the RFID tag contained information includes battery pack

7. The system of claim 1 wherein the RFID tag is one of the following: an inductively coupled RFID tag and a capacitively coupled RFID tag.

8. The system of claim 1 wherein the RFID tag is one of the following: an active tag and a passive tag.

9. The system of claim 1 wherein the RFID tag is one of the following: a read-write RFID tag, a WORM RFID tag, and a read only RFID tag.

10. The system of claim 1 wherein the RFID tag is one of the following: a low frequency RFID tag, a high frequency RFID tag, a UHF RFID tag, and a microwave RFID tag.

11. The system of claim 1 wherein the RFID tag includes at least one of the following: an integrated circuit chip and a paper label.

12. The system of claim 1 wherein the battery pack includes a battery and the RFID tag is affixed to the battery.

13. The system of claim 1 wherein the battery pack includes a battery pack case having an inside surface and the RFID tag is affixed to the inside surface of the battery pack case.

14. The system of claim 1 further comprising an RFID reader configured to read information from the RFID tag while being physically separate from the RFID tag.

15. A system comprising:
at least one battery
a battery pack case, the battery being positioned inside of the battery pack case;
an identifier containing information, the identifier affixed to at least one of the battery pack case and the battery inside of the battery pack case; and
a reader configured to obtain the information from the identifier while the reader is positioned outside of the battery pack case and the identifier is positioned inside of the battery pack case.

16. The system of claim 1 wherein the identifier is an RFID tag.

17. The system of claim 1 wherein the identifier is one of the following: a transponder device and a contactless chip card.

18. A method comprising:
providing an RFID tag;
providing a battery pack;
affixing the RFID tag to the battery pack; and
using an RFID reader to obtain information about the battery pack.

19. The method of claim 18 further comprising storing information regarding the battery pack into the RFID tag.

20. The method of claim 19 further comprising reading the stored information from the RFID tag with an RFID tag reader while the RFID tag remains physically separate from the battery pack and the RFID tag.

21. A method comprising:
organizing a plurality of battery packs into an arrangement;
locating an RFID reader in a vicinity of the arrangement of battery packs; and
collecting information about the battery packs with the RFID reader while the RFID reader remains in the vicinity of the arrangement of battery packs and the battery packs remain in the arrangement.
